(19) United States
(12) Patent Application Publication
(10) Pub. No.: US 2012/0050531 A1
(43) Pub. Date: Mar. 1, 2012

(54) CARGO CONTAINER SECURITY SYSTEM

(76) Inventor: Albert T. Wu, Paramus, NJ (US)

(21) Appl. No.: 12/869,594

(22) Filed: Aug. 26, 2010

(51) Int. Cl. H04N 7/18; G11B 23/00; G08B 21/00

(52) U.S. Cl. 348/143; 340/540; 369/263.1; G9B/23; 348/E07.085

(57) ABSTRACT

A cargo container security system and method, including a cargo container with at least one sensor for detecting an open or closed status of a door on the cargo container and a geographic positioning locator for identifying a location of the cargo container. A control unit, located on the cargo container and operatively connected to the at least one sensor and geographic positioning locator, continuously receives historical data corresponding to at least the status of the cargo container door and location of the cargo container while the cargo container is in transit. The control unit assigns a timestamp to the received historical data, and stores the received historical data and associated timestamp in memory. A central computer system receives and analyzes the stored historical data for any anomalies upon the arrival of the cargo container at a destination. The central computer system generates an alert if an anomaly is identified.

### BACKGROUND

1. Field of the Invention

This disclosure relates generally to commercial shipping and, more particularly, to securing cargo containers against smuggling, tampering and other illicit acts during the shipping process by preventing en-route alteration of cargo container contents.

2. Background

Cargo containers have been the mainstay of the international shipping industry for well over half a century. The standard corrugated steel construction of a cargo container provides an excellent degree of protection against weather, accidental damage and illicit intrusion while maintaining a high degree of cost effectiveness. Their existence has largely enhanced international commerce and benefited economic globalization.

However, the closed nature of the cargo container also presents serious security concerns because there is no simple mechanism by which a customs service or other border control agency can discern the contents of a container without a thorough inspection. This is too high a risk to ignore, especially considering the severity of current international terrorism, piracy, drug smuggling and human trafficking

In response, customs agencies often perform targeted and random inspections of the contents of suspect cargo containers. These range from simple solutions, such as opening the cargo container and manually inspecting the shipping contents, to more complex technological solutions, such as scanning the cargo container with a powerful X-ray device. However, all of such methods currently are inadequate and impose huge burdens on the customs service. For example, opening a container for manual inspection is time intensive, because the process invariably requires locating one container in the storage area, acquiring it (possibly requiring the movement of many other containers), bringing it into a specific examination area, and then conducting a scheduled inspection by coordinating the availability of both customs agents and representatives of the importer, who justifiably have a duty to protect whatever cargo is inside the container on behalf of their clients. The actual inspection itself is time consuming as well, as it requires removing all the cargo from the container and opening the individual cargo packages to see if their contents accurately reflect what has been declared. Once that is completed, the cargo must be repackaged and reloaded into the container.

While X-raying a suspect cargo container may be faster than a manual inspection of its contents, X-ray inspection still requires acquisition and transport of the cargo container, in addition to a large dollar investment necessary to procure the X-ray equipment, processing facilities, electricity necessary to operate the X-ray equipment and trained staff necessary to conduct the scan.

Inspection-based solutions are hampered by more than mere logistical problems. Shipping harbors and transport hubs are often located close to or within large civilian populations. A cargo container sabotaged against inspection by explosive devices may cause an extreme amount of damage, both to the shipping hub itself, any inspection facility, customs inspection personnel and the surrounding civilian population. Worse yet, the shipping hub itself may be the desired target, as damage to any region's major hubs may seriously disrupt trade to the region. Inspection-based shipping security solutions are completely inadequate to safeguard against this kind of threat.

In light of the fact that millions of cargo containers are shipped to and from the US, and indeed, most other countries every year, it is clear that these conventional inspection-based solutions are insufficient because the cost and time associated with inspecting every cargo container would be prohibitively large, making such a security system impractical. Moreover, even if every cargo container could be inspected using conventional inspection techniques, the delay associated with inspecting each cargo container would likely have the effect of choking off international commerce.

Therefore, a new security system and method is required for protecting cargo containers and their contents from tampering, sabotaging and other illicit activity.

### BRIEF SUMMARY

In one aspect of this disclosure, a cargo container security system and computer-implemented method are disclosed. A cargo container includes at least one sensor for detecting a status of a door on the cargo container, wherein the status of the door is open or closed. The cargo container also includes a geographic positioning locator for identifying a location of the cargo container. A control unit, located on the cargo container and operatively connected to the at least one sensor and geographic positioning locator, continuously receives historical data corresponding to at least the status of the cargo container door and location of the cargo container while the cargo container is in transit. The control unit assigns a timestamp to the received historical data, and stores the received historical data and associated timestamp in memory. A central computer system, including a processor and memory, receives the stored historical data upon the arrival of the cargo container at a destination. The processor analyzes the stored historical data to determine whether there are any anomalies associated with the status of the cargo container door and/or the location of the cargo container during transit. The processor generates an alert if an anomaly is identified.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a partially cut away, perspective view of an exemplary cargo container that may be used to implement the operating procedure and system for secured container shipping;

FIG. 2 is a partial, side elevation view of the exemplary cargo container taken along line A-A in FIG. 1;

FIG. 3 illustrates an exemplary monitoring subsystem that may be used to implement the operating procedure and system for secured container shipping;

FIG. 4 is a flow-chart diagram illustrating a series of exemplary steps that may be used to implement the operating procedure and system for secured container shipping; and

FIG. 5 is a continuing flow-chart diagram illustrating a continued series of exemplary steps that may be used to implement the operating procedure and system for secured container shipping.

### DETAILED DESCRIPTION

This application discloses a specialized security system and method for secured shipment of international cargo containers that will achieve two seemingly contradictory goals simultaneously. First, the preferred operating procedure and system will secure contents inside shipping containers against smuggling, tampering and other illegal and/or dangerous activities, thereby closing security loopholes extant in the current system. Second, the preferred security system and method will expedite the customs declaration and inspection process for export and import.

The security system and method disclosed herein preferably achieve these two disparate goals by continuously monitoring the status of the cargo container during all phases of the shipping process. In a preferred embodiment, every detail of the cargo container shipment is time stamped and recorded (in multiple ways, including video recording), starting from initial loading to final unloading and exit.

The preferred security system and method will not require heavy investment in facilities or manpower from the government or significant modification to standard import and export procedures. The preferred security system and method will also retain compliance to World Trade Organization, General Agreement on Tariffs and Trade (and other international bilateral trading agreements), and generally close the security loopholes in the current system while beneficially accelerating customs procedure in normal practice.

Therefore, cargo containers that successfully follow the security system operating procedure to the letter (as verified by the operating system), may pass through import and export customs without need for inspection, because the preferred security system and method are designed to close every possible loophole, and deny every possibility of tampering, sabotage or other illicit shipping behavior en-route. Cargo containers that have seen deviations from the security system operating procedure, may, on the other hand, be subject to vigorous inspection, which may take multiple forms, some of them expedited by the operating subsystem and equipment used for monitoring the cargo container in-transit (as will be discussed below). This may reduce the cost of such inspections and alleviate the need for specialized facilities for all but the most onerous manual inspections.

The preferred security system and operating procedure may be protected against counterfeiting, hacking and other such breaches. Counterfeiting is a risk to the system because it may allow a perpetrator to create false trip information, thereby slipping illicit cargo into the shipping system or enabling some other illicit activity, such as stealing legitimate cargo en-route. Hacking, similarly, may allow a perpetrator to alter system data at will. Therefore, preventing counterfeiting and hacking is desirable to enhance confidence in the security system and operating procedure.

The security system and method disclosed herein may be designed and produced as a closed proprietary system. It may employ application specific integrated circuits (ASIC) hardware in conjunction with an operating system (OS) with proprietary modifications. The ASIC hardware and OS are preferably so closely intertwined that any slightly deviation in any device in the security system will be detected and render it useless. In addition, the ASIC hardware and OS should preferably be designed so that attempts to reverse engineer the system will require multi-million dollar investments along with years of effort, thereby reducing or eliminating the possibility of system intrusion.

Communication networks utilized by the security system and method disclosed herein may be designed as a proprietary independent network. Connection between domestic agency offices and trading partner countries are preferably constructed or comprised of secured communication lines to prevent or deter hacking. Layers of proprietary communication protocols among domestic and foreign custom offices may be utilized to further increase defense effectiveness against hacking

The security system and method for secured container shipping may utilize two primary subsystems—a monitoring/surveillance subsystem and a monitoring station subsystem. These subsystems preferably follow a well-defined cooperative operating procedure to ensure the integrity of the security system and operating procedure for secured container shipping.

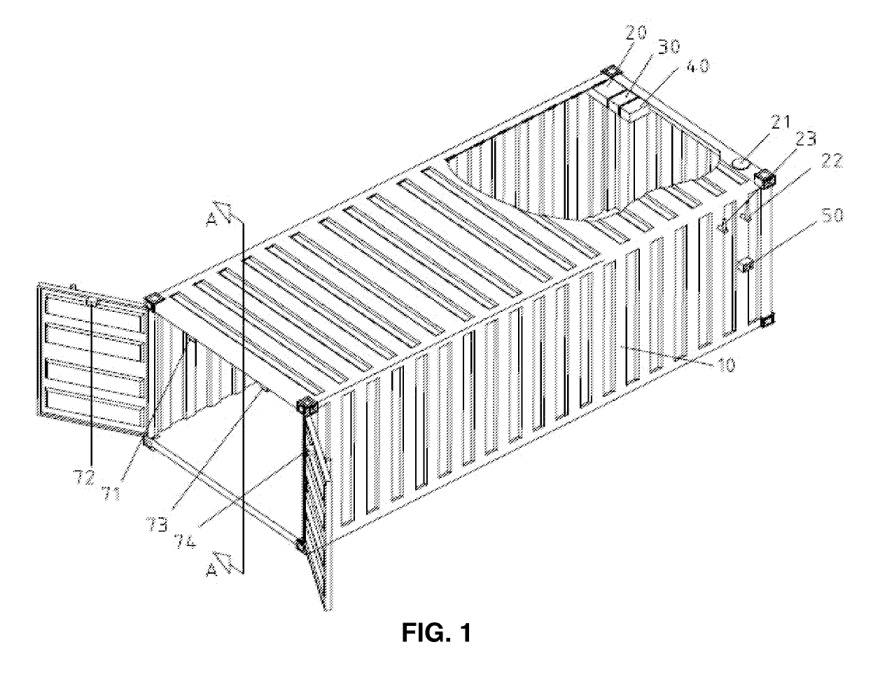

Turning now to the drawings, FIG. 1 is a partially cut away, perspective view of an illustrative cargo container 10 that may be used to implement the security system and operating procedure for secured container shipping. Cargo container 10 may be equipped with the monitoring/surveillance subsystem of the security system and operating procedure for secured container shipping. The monitoring/surveillance subsystem may include one or more of the illustrated devices, as necessary to implement a degree of desired security. The monitoring/surveillance subsystem may correlate available data, such as time-stamped tracking information, global positioning system (“GPS”) data on a shipping route, and image and/or video recordings from surveillance equipment. This information may be utilized to determine whether the cargo container 10 requires special attention because of some kind of deviation in the security system operating procedure protocol (such as, for example, the cargo container doors opening en-route, as recorded on a surveillance camera; or the cargo container dwelling in a unexpected or unexplainable area for a suspicious amount of time, as determined by GPS data).

The monitoring/surveillance subsystem preferably includes a control unit 20, which preferably includes a processor or central processing unit, high capacity non-volatile mass storage, and one or more communication ports. The processor of control unit 20 is preferably responsible for controlling the other peripherals/components of the monitoring/surveillance subsystem, and real-time processing and storing of data/information streaming in from the other peripherals stored on its high capacity non-volatile mass storage. The control unit 20 preferably also communicates with portable memory unit 210. Each time portable memory unit 210 is mated with the control unit 20, time and location information for the mating event may be stored on both units. Portable memory unit 210 preferably contains custom declaration information but may also hold an encryption key, as described further below. The control unit 20 preferably supports many popular communication standards, including (but not limited to) universal serial bus, category five cable, etc.

Control unit 20 preferably includes or is operatively connected to at least one storage device used to record data, including (but not limited to) processed image data and GPS data, with sufficient capacity to record the data in its entirety. The control unit 20 may also be adapted to store other types of information as well, if desired. Storage may be implemented, for example, via a high capacity mass storage device, such as a hard disk drive. If a hard disk drive is utilized, a vibration dampening device is preferably included to prevent damage to the hard disk (and data integrity) caused by movements of the cargo container during loading and shipping. One suitable vibration dampening device is disclosed in applicant's co-pending U.S. patent application Ser. No. 12/611,868, entitled “Thermally Controlled, Anti-Shock Apparatus For Automotive Electronics,” which is incorporated by reference herein. The “Thermally Controlled, Anti-Shock Apparatus” has the additional benefit of controlling temperature extremes and maintaining a level of operating temperature stability. Alternatively, a solid-state drive, although currently expensive, may be utilized if desired. The use of a solid-state drive may become more attractive as the technology matures and the associated costs are reduced.

All surveillance data stored by the control unit 20 is preferably time-stamped and may also be encrypted to deter tampering and enable meaningful review. The surveillance data is preferably stored by the control unit 20 in a compressed format. All the surveillance data stored by control unit 20 for a particular cargo container 10 shipment preferably comprises a single data block. The size of this data block will preferably increase as new event progresses and new data packet will be added to the block. In the preferred embodiment, once the surveillance data is written or stored by the control unit 20, the content of the stored data block may not be altered. Only after the custom agency of the importing country signals acceptance of the data block and makes a permanent copy for its archive in the system (described further below), then the data block may be erased in its entirety to vacant the space for the next cargo container shipment.

Control unit 20 preferably allows partial writing of data to the data block. Once a piece of data is added, it preferably resides there semi-permanently, and is only erasable with the entire block by way of a special procedure (described later below). Executable programs operable on control unit 20, in particular, are preferably hard coded (or otherwise write-protected) from the manufacturing factory. Denying full write/delete access may deter hacking once the control unit 20 leaves the factory. In short, the system may favor security over upgradeability.

The control unit 20 is preferably installed on or within the cargo container 10 in such a way as to maximize available cargo space within the container and maintain ease of loading, while retaining full functionality of and minimizing risk of damage to the control unit 20. A position near the back or rear of the cargo container 10 away from the doors may be preferable, as illustrated in FIG. 1. The mounting fixtures (perhaps in combination with the design of a case or housing for control unit 20) are preferably designed so that once installed, control unit 20 cannot be removed or accessed without irreversible mechanical or electrical damage to the control unit. This may serve as another layer of protection against tampering.

Communication ports for connecting to control unit 20 are preferably located on both the interior and exterior walls or surfaces of cargo container 10, allowing access to control unit 20 from both the interior and exterior of container 10. If external communication ports are provided on cargo container 10, it may be beneficial to group them at a single access point, such as the illustrative junction box 50 shown in FIG. 1.

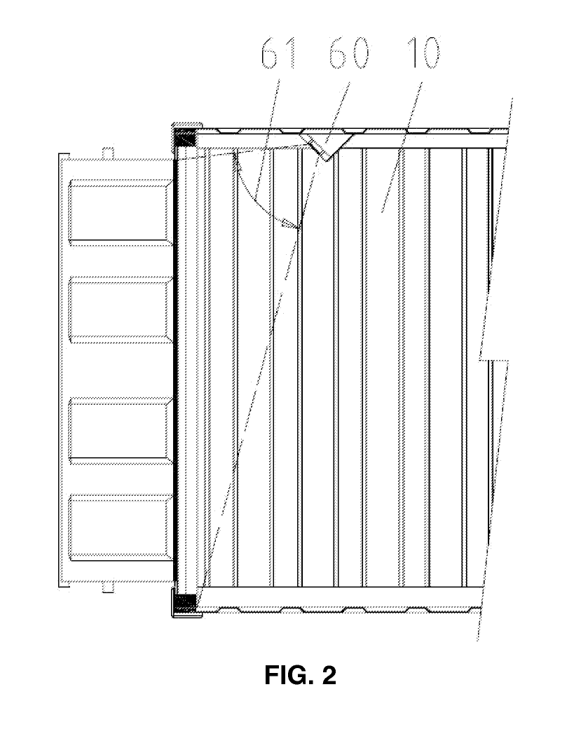

Surveillance data may be provided by one or more surveillance sources within the monitoring/surveillance subsystem, which may include (but is not limited to) door camera 60 (shown in FIG. 2), GPS antenna/receiver 21 and proximity sensors 71-74.

As depicted in FIG. 2, the monitoring/surveillance subsystem preferably includes at least one door camera 60 preferably mounted within the interior of the cargo container 10 so that the viewing angle 61 of the camera 60 captures/records the entire door opening of cargo container 10. Camera 60 may be supplemented with additional cameras installed in other locations, on the interior and/or exterior of the cargo container 10, as desired. Door camera 60 is preferably positioned to minimize any potential hindrance to loading and unloading cargo within cargo container 10 while maintaining visual coverage of the cargo container door(s). A balance may need to be struck between these two competing concerns. Door camera 60 is preferably capable of recording light from multiple spectrums in addition to the visible spectrum (e.g., visible light, infrared, etc.), enabling the camera to record in low light or no-light conditions. If so equipped, camera 60 is preferably able to communicate the lighting condition to control unit 20 so that control unit 20 (or computer system 110) can accurately interpret the information received from camera 60. This would preferably allow camera 60 and control unit 20 to record information about the cargo container 10 in as many lighting conditions as feasibly necessary. For example, an infrared camera 60 may detect a perpetrator utilizing night vision goggles to infiltrate cargo container 10 in complete darkness. This information may be appropriately interpreted, saved and time-stamped by control unit 20, allowing later inspecting authorities to detect the intrusion.

Returning to FIG. 1, the monitoring/surveillance subsystem also preferably includes GPS antenna/receiver 21 to receive signals from global positioning satellites to triangulate the approximate position or location of cargo container 10. GPS receiver/antenna 21 is preferably mounted on the highest point feasible on the exterior of the cargo container 10 without risking damage to the GPS receiver/antenna 21 in the normal course of shipping operations (e.g., loading containers, stacking containers, etc.). GPS antenna/receiver 21 may transmit to or otherwise provide control unit 20 with real-time or periodic update information on global latitude and longitude coordinates, as well as elevation information and a highly accurate timing signal.

The monitoring/surveillance subsystem also preferably includes proximity sensors 71-74, which may be electro-magnetic sensors, photoelectric sensors, optical sensors, or any other suitable sensor capable of detecting whether the cargo container doors are open or closed. Proximity sensors 71-74 are preferably mounted on or within the cargo container 10 to detect the open or closed status of the cargo container doors. Signals from the proximity sensors 71-74 are preferably transmitted to control unit 20 so that control unit may record the state of the cargo container doors (i.e., opened or closed) at all relevant times. The proximity sensors 71-74 may also be able to detect small and/or partial openings of the cargo container doors in the event an intruder attempts to slip something small into or out of the cargo container 10 (e.g., an envelope with a harmful biological agent). Although four proximity sensors 71-74 are illustrated in FIG. 1, any number of sensors may be utilized that will satisfactorily monitor the open and closed states of the cargo container doors.

Other optional components may be included in the surveillance/monitoring subsystem installed on and within cargo container 10. For instance, battery 40 is preferably provided to maintain operation of control unit 20 and subsystem components (such as (but not limited to) camera 60 and proximity sensors 71-74) even when the subsystem is not connected to an active power source. Battery 40 is preferably selected so as to provide sufficient power to comfortably maintain operation of control unit 20 and the other subsystem components during all phases of shipping. Battery 40 may be installed or otherwise mounted in a location that presents the least amount of hindrance to loading and unloading cargo into or from the cargo container 10, while remaining feasibly protected from external shock and damage. To save weight and volume, battery 40 is preferably constructed of material having the highest energy density available. Considerations may also need to be taken with respect to the shipping route. For example, routes where cargo container 10 is without an external power source for large periods of time may invariably require longer lasting or multiple batteries 40 to ensure adequate power reserves for control unit 20 and the various components of the surveillance/monitoring subsystem. Seventy-two hours, for example, may be a generally suitable time period for a majority of cases.

The surveillance/monitoring subsystem may also include a power management unit 30 mounted or otherwise positioned on or within cargo container 10 to ensure delivery of the appropriate electric power supply to control unit 20. When an external power source is connected to cargo container 10, power management unit 30 preferably functions as a power converter to supply the correct current at the appropriate voltage to the control unit 20, protecting the control unit from electrical damage. Simultaneously, power management unit 30 may divert some portion of available electrical power to charge battery 40. When the cargo container 10 is disconnected from an external power supply, power management unit 30 preferably draws energy from battery 40 to provide electricity to control unit 20 and operating subsystem components (such as (but not limited to) camera 60 and proximity sensors 71-74).

When the battery 40 is running low, power management unit 30 preferably provides or otherwise transmits a low battery alert signal to control unit 20, which may then initiate a notification to warn an external system operator or human operator of the low battery condition. If battery 40 drains completely, control unit 20 preferably performs an orderly power down procedure, which includes saving a full record of the power down event, including time-stamp. Any power failure preferably raises the alert status of the particular cargo container 10 and may require authorities to inspect the container, as the system can no longer guarantee the security integrity of the container 10 during power down situations. The additional cost of this inspection may be allocated to the party responsible for maintaining power supply to all available cargo containers 10 at the time of power failure to discourage power down situations from repeating themselves.

The monitoring/surveillance subsystem also preferably includes wireless local area network (WLAN) antenna 22 and cellular antenna 23, which are preferably mounted on or otherwise positioned on cargo container 10. WLAN antenna 22 communication preferably conforms to Institute of Electrical and Electronics Engineers (IEEE) standard 802.11. Cellular antenna 23 communication preferably conforms to 2G/2.5G/3G and 4G communication protocols. Both WLAN antenna 22 and cellular antenna 23 may be installed on or near the highest exterior location of cargo container 10. Internally, both antennae 22, 23 may be operatively connected to control unit 20, giving control unit 20 additional means to communicate wirelessly to external systems. As before, proprietary hardware encoding, software encryption and/or other means may be used to secure both the physical hardware systems from tampering, and eavesdropping or alteration of communications to external systems.

As mentioned above, junction box 50 may be provided on cargo container 10 to house electrical and communication connection ports that may be used to operatively connect external systems to the monitoring/surveillance subsystem of cargo container 10. Both junction box 50 and its respective connectors are preferably designed to resist a wide range of environmental conditions, including (but not limited to) inclement weather, heat, humidity, corrosion, salt, etc. Additionally, the communication ports may be designed to allow quick and easy connection and disconnection to facilitate the efficiency of the shipping process. The structure of the junction box 50 is preferably reinforced to make it durable against impact and accidents that may occur during the loading and handling of cargo containers 10.

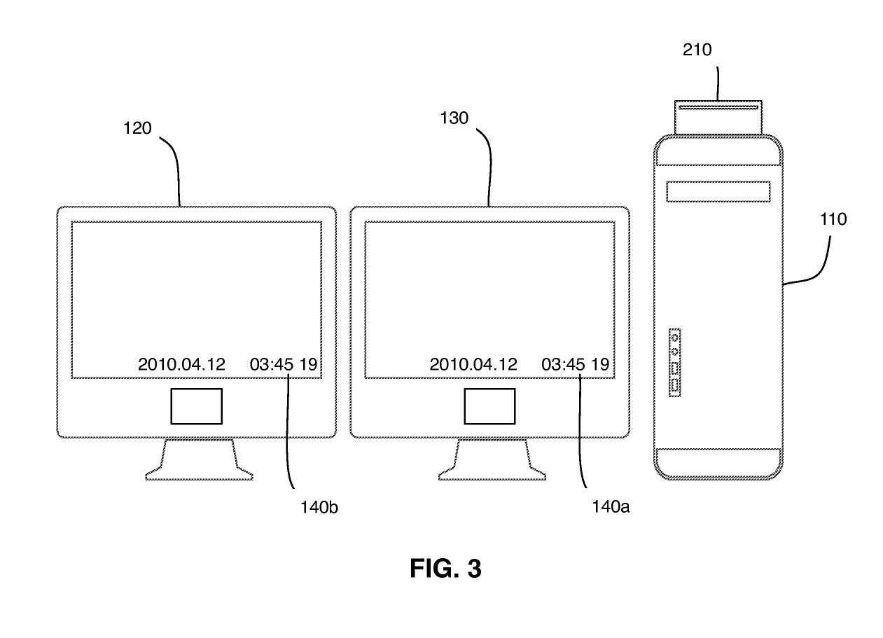

FIG. 3 depicts an illustrative interface subsystem that may be used to implement the security system and method/operating procedure for secured cargo container shipping. One or more computer system 110 may be utilized to serve as a central processing unit or system for the illustrative monitoring subsystem. The computer system 110 may take the form of any computer system suitable for carrying out the desired functions of the interface subsystem. The computer system 110 preferably includes computing components for executing computer program instructions and processes. These components may include (but are not limited to) a processor or central processing unit (CPU), memory, input/output (I/O) devices, and a network interface. Preferably, because of their cost-effectiveness, computer system 110 may be one or more high-end personal computers, which may include Intel® or AMD™ type processors. However, other types of computers and processors may be utilized as desired.

The processor processes and executes computer program instructions on computer system 110. Random access memory (RAM) and/or fast access cache memory preferably provides fast data supply to the processor of computer system 110. Long-term storage may be provided as a more permanent form of computer memory on computer system 110, and may be, for example, a hard disk, optical disk, flash memory, solid-state memory, tape, or any other type of memory.

The I/O device(s) permit human interaction with the computer system 110, such as (but not limited to) a mouse, keyboard and computer display. I/O device(s) may also include other interactive devices, such as (but not limited to) touch screens, digital stylus, voice input/output, etc.

The network interface device may provide the computer system 110 with access to a network, which may be a wireless or wired connection. The network may be, for example, the Internet, an intranet, or any other computer network through which computer system 110 may connect to or otherwise communicate with other computers and devices, such as (but not limited to) control unit 20 of the monitoring/surveillance subsystem.

Computer system 110 may utilize a commercially available operating system, such as (but not limited to) Windows®, OS/X Leopard® or Linux operating systems. Alternatively, a custom proprietary operating system may be used (perhaps for increased resistance against digital infiltration and hacking) In either case, software may be executed by the processor of computer system 110 to implement the interface subsystem sub-functions. The software may include one or more proprietary software suites that install and co-function on the particular operating system running on computer system 110. Alternatively, the software suites may be incorporated as part of a proprietary operating system running on computer 110, if one is used.

The software suite (or suites) preferably performs at least two primary functions. The first function is documentation processing, and the second function is decoding and displaying trip data recorded (and preferably encrypted) by the monitoring/surveillance subsystem of FIGS. 1 and 2. The software suite responsible for documentation processing preferably communicates with the portable memory unit 210, where the custom declaration information and decryption key generation information are stored. Once this information is successfully processed, the surveillance data is preferably immediately intelligible to the software suite (or suites) without need for conversion or other intermediary processes. Some or all data (such as, for example, the trip data, possibly including GPS data, time stamps, etc.) may have been encrypted for protected transmission from control unit 20 to computer 110. The software suite (or suites), therefore, preferably has the ability to decode encrypted data for display or further processing. This may be accomplished, for example, by allowing computer 110 to use a proprietary encryption algorithm (matched to the encryption algorithm used on control unit 20) to generate an decryption key, which may then decode the data to be displayed or otherwise processed.

Software process or processes and executables on the computer system 110 may also be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computer system 110, partly on the computer system, as a stand-alone software package, partly on the computer system and partly on a remote computer or server, or entirely on a remote computer or server.

One or more display terminals 120, 130 may be utilized to display trip and surveillance data collected by and received from the surveillance/monitoring subsystem. Display of this data may be useful in aiding a customs agent or other governing authority to oversee and review information collected by the control unit 20 and transmitted to computer system 110. While two display terminals are illustrated in FIG. 3, any number of display terminals may be used with computer system 110.

Display terminals 120, 130 may be set to display different types of information. For instance, display terminal 120 may display a representative map in conjunction with a timestamp 140b, preferably accurate to the second (as shown). This may display both real-time and historical location information for the cargo container 10 as recorded by control unit 20, enabling a customs authority to review the progress of the cargo container 10 and note if any detours or anomalies have occurred during transit (thereby raising suspicion and the need for further investigation).

In contrast, display terminal 130 may, for example, display image and/or video data recorded by surveillance camera 60 within a particular cargo container 10 and received from the surveillance/monitoring subsystem of that cargo container. The timestamp at the bottom of the display terminal 130 evidences that the image displayed on terminal 130 was taken in synchronization with the GPS data displayed concurrently on display terminal 120. In other words, the video image displayed on display terminal 130 was taken exactly when the cargo container 10 was at the location shown on the map displayed on display terminal 120.

Because of the large quantity of image and video data available for a long transit, the software suite operating on computer system 110 preferably includes image recognition software that recognizes certain image patterns, such as (but not limited to) the opening and closing of the cargo container 10 doors. For example, if the image displayed on display terminal 130 shows a bright vertical column in the center and two dark blocks on either side of the bright vertical column, then this may indicate that the cargo container doors were ajar when the image was recorded by camera 60 at this specific time and location shown on the map displayed on display terminal 120. The computer system 110 may, therefore, identify exactly when and how many times the cargo container 10 doors were opened, with an accompanying timestamp 140a for each opening and closing event. Deviations from the expected pattern of opening and closing doors may indicate that cargo container 10 requires further investigation or inspection. The computer system 110 will preferably provide an alert that a suspicious activity occurred during transit.

Display terminals 120, 130 may be set up to display other information as well, including (but not limited to) data collected from external devices connected to junction box 50, proximity sensors 171-174, power management 30 and battery 40, WLAN antenna 22 and cell phone antenna 23.

Portable or external memory unit 210 may be utilized in conjunction with both the surveillance/monitoring subsystem (control unit 20) and the interface subsystem (computer system 110). Portable memory unit 210, as its primary function, preferably stores any custom declaration information (including any associated customs forms) and shipping information associated with cargo container 10, and interfaces with both subsystems through proprietary communication protocols, both hardware and software. Portable memory unit 210 may require only a small or moderate amount of storage capacity to fulfill this role.

Portable memory unit 210 may have secondary optional uses as well. For example, it may be used to physically transfer data between control unit 20 and computer system 110. Portable memory unit 210 may also be used to back-up data from control unit 20, augment its memory capacity, or even provide copies of records for use with external or third party systems. However, portable memory unit 210 may require significant alteration to suit these additional secondary roles, as the storage capacity of portable memory unit 210 would have to be increased greatly for it to accommodate, for example, the large volume of surveillance data accumulated during a single trip.

Portable memory unit 210 preferably disallows any recorded data from being erased or altered during a shipping session. Every time portable memory unit 210 interfaces with any subsystem, a record of that interaction is preferably written into memory. This enables portable memory unit 210 to track every connection it shares with other systems. Data written on portable memory unit 210 preferably cannot be deleted from the memory unit during shipping. An optional function may be provided to enable erasure of the content of portable memory unit 210. This optional function is preferably used only at the end of a shipping session, and its use is preferably limited only to a customs official, or other valid personnel. Portable memory unit 210 may be built with a proprietary protocol on any popular bus system architecture, such as universal serial bus. It preferably keeps a record timestamp of every interface it has with another device, while leaving a record of itself on the coupled device as well (namely, computer system 110 and control unit 20). This preferably safeguards against hacking and counterfeiting by leaving a cross-checkable trail of records to document its existence and usage.

During transit of cargo container 10, the portable memory unit 210 will preferably be located inside junction box 50 on the cargo container 10 and be in constant connection with control unit 20. Therefore, any anomaly in the monitoring/surveillance subsystem (e.g., a total power failure) will be duly recorded.

Portable memory device 210 preferably starts as a blank and is preferably initialized by the interface subsystem (computer system 110) under the control of the custom office of the exporting country. The initialization information may be unique and with personality. After the cargo container 10 successfully clears the exporting inspection, the encrypted initialization information along with step-by-step record will preferably be dispatched to the corresponding custom office of the importing country via a secured line of communication. As mentioned above, portable memory device 210 preferably accompanies the cargo container 10 during transit, until the memory device 210 is handed over to the custom office of the importing country at the port of entry. This ensures the authenticity of the content of the portable memory device 210. As a further safeguard, the portable memory unit 210 may be initialized with an export declaration to create encryption keys. When the portable memory device 210 is mated to the control unit 20 (via junction box 50), the portable memory device 210 may provide an encryption key and form a unique pair with control unit 20. Afterwards, all data recorded by control unit 20 is preferably decodable only with the aid of the encryption key (or keys) contained in that singular portable memory unit 210, or, in an alternative embodiment, encrypted information dispatched from the custom office of the exporting country via secured communication lines, if available.

A dangerous potential for security breach may be anticipated at this juncture. The agents responsible for moving the portable memory device 210 to (and from) the cargo container 10 at the exporting port (and vice versa, at the importing port) may have been compromised. If that were true, then the entire process may be deficient if the agent can alter customs data and surveillance information at the exporting port or importing port. To minimize this risk, a special security feature is preferably incorporated into the portable memory unit 210. The special security feature may utilize a reserved data block that contains an encryption key. In the reserved data block, whenever a “read” command is executed, a “write” cycle may automatically follow, writing over the area with random data (such as a random collection of numbers). Normally, when control unit 20 reads the encryption key, it preferably waits until the write cycle is completed, and then writes the decryption key into the reserved data block to override the random data. This decryption key may then be used at the import customs agency to decode the surveillance information recorded by control unit 20.

If an export agent were compromised, the agent might attempt to read the encryption key of portable memory unit 210 in order to decode and alter the encrypted content recorded by control unit 20. However, by his very act, the key(s) he reads will no longer be valid, because control unit 20 preferably recognizes the random numbers overwriting the original key as a valid key. This preferably frustrates the illicit access attempts of the compromised agent.

If an import agent were compromised, the agent might attempt to read the decryption key(s) deposited in portable memory unit 210 by control unit 20 when it first read the encryption key(s). Again, the very act of attempting to access the decryption key preferably causes the decryption key(s) to be altered automatically. As a result, computer system 110 will no longer be able to decode the recorded trip information with the decryption key(s) stored in portable memory unit 210. Subsequently, the system preferably issues an alert and may flag container 10 as suspect.

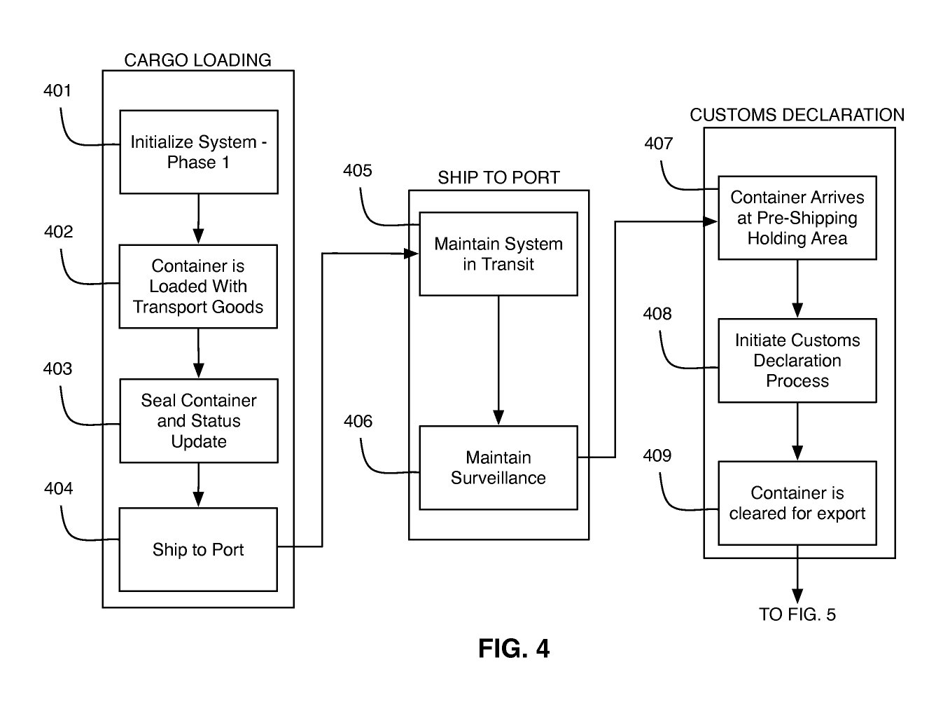

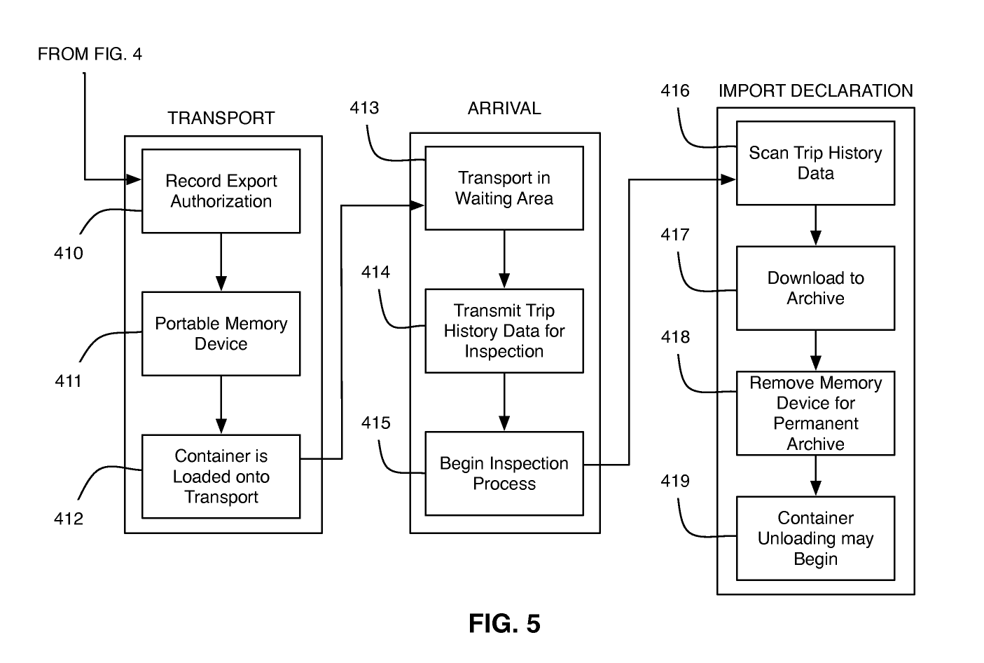

Having described the preferred subsystems and components that may be utilized in the security system and operating procedure for secured container shipping, we turn now to FIGS. 4 and 5, which are a flow-charts illustrating a preferred sequence of steps that may be used to implement the security system and method for secured container shipping.

In step 401, the surveillance/monitoring subsystem and interface subsystem are initialized. If a portable memory unit 210 is to be used, then it is preferably initialized to a ready state at the exporting customs office and then operatively connected to control unit 20. External power is preferably connected to the cargo container 10 for use during transit. Control unit 20 may then be powered up and instructed to begin recording data for a new shipment session. Control unit 20 may then commence recording activity via external inputs, such as (but not limited to) camera 60, GPS antenna 21, proximity sensors 71-74, etc. This recorded surveillance data is preferably stored on the high capacity mass storage device (or devices) contained within or as part of control unit 20.

In step 402, transport goods may be loaded into cargo container 10. Control unit 20 preferably records the entire loading session via external inputs, such as (but not limited to) camera 60. Once loading is complete, the cargo container 10 may be sealed in step 403. The control unit 20 preferably recognizes automatically that the cargo container doors have been sealed via inputs, such as (but not limited to) camera 60 and proximity sensors 71-74. The cargo container 10 is preferably not opened again unless absolutely necessary (e.g., if the custom authorities decide to undertake an inspection). While the cargo container 10 is being loaded, control unit 20 and the other components of the surveillance/monitoring subsystem preferably draw power from an external power source via junction box 50. If no external power source is available, the surveillance/monitoring subsystem preferably draws power from the battery 40 so that there is no gap in surveillance. In the latter case, some relevant authority (e.g., the exporter, port manager, etc.) preferably ensures that the loading period duration is short enough as to be adequately supported by battery 40. Once cargo container 10 is sealed, then in step 404, the container 10 may be loaded onto transport and shipped to the exporting port.

In step 405, the surveillance/monitoring subsystem preferably remains in continuous operation while the cargo container 10 is en-route to the exporting port. The surveillance/monitoring subsystem preferably draws power not from battery 40, but from an external power source (e.g., the electrical system on a semi-trailer truck), which may be operatively connected to cargo container 10 through junction box 50. This ensures constant operation of the surveillance/monitoring subsystem and keeps the back-up battery 40 at full charge in the event of a power disruption.

In step 406, surveillance is preferably maintained in transit through the surveillance/monitoring subsystem components. In particular, surveillance camera 60 continues to record images and/or video of the doors of cargo container 10 to ensure that the doors are not opened during transit. GPS antenna 21 regularly updates the position of the cargo container 10. All of this surveillance data is preferably recorded by control unit 20.

In step 407, cargo container 10 arrives at the exporting port and the export customs process may begin in step 408. The customs declaration may be filed, partially or fully electronically benefited by the customs data available on the portable memory device 210. This information is preferably transmitted to an interface subsystem running on one or more computer systems 110. The information may be transmitted in any manner suitable, such as (but not limited to) hard line coupling to junction box 50, wireless transmission via wireless antenna 22, or (preferably) direct physical transport in portable memory device 210.

Data from the monitoring/surveillance subsystem (e.g., images and video from surveillance camera 60, and proximity information from proximity sensors 71-74) may be downloaded from control unit 20 and copied onto a permanent record (for instance, onto a Digital Video Disk) for archiving by the authorities. Data from the surveillance camera 60 may be scanned or otherwise reviewed to detect possible illicit intrusions into the cargo container 10. Scanning may be performed manually, but is preferably performed by a visual pattern recognition software. If an anomaly is detected, cargo container 10 may be identified for more thorough inspection by the authorities. In the event an inspection is performed, control unit 20 preferably continues recording all aspects of the inspection process as long as it is practical. If no anomaly is detected (or once inspection is completed), cargo container 10 is preferably authorized for export in step 409.

Referring to FIG. 5, export authorization is preferably recorded in step 410. If the portable memory device 210 was removed for the export customs processing, then in step 411, it is preferably reconnected to the control unit 20 mounted on cargo container 10. Export authorization may be duplicated on the portable memory device 210 once it is reconnected to the monitoring/surveillance subsystem. Reconnecting the portable memory device 210 to continue storing customs information is preferably required before the export process can continue.

Finally, in step 412, the cargo container 10 may be loaded onto a transport and exported to its final destination. As before, while in transit, cargo container 10 is preferably connected to an external power source (e.g., an electrical power circuit on a seaborne freighter) to supply constant power to control unit 20 and the subsystem components, and ensure that back-up battery 40 is fully charged in the event of a power failure. During all intervals in which control unit 20 is not connected to an external power source, control unit 20 preferably receives constant power from back-up battery 40.

Additionally, transport-based communication systems may be used in place of the monitoring/surveillance subsystem devices if the subsystem devices are blocked. For example, it is conceivable that because cargo containers (such as container 10) are often stacked one on top of another, the GPS antenna on all but the topmost containers may have their signal blocked, rendering them inoperative (assuming they are not stored below decks, in which case, all of them are likely to be inoperative). Some or all cargo containers 10 on the transport (e.g., freighter) may, therefore, be networked to each other to utilize the navigational GPS solution from cargo containers with a functional GPS signal. Alternatively, the cargo containers 10 may be networked to the transport's own GPS (via, for example, junction box 50) and utilize the transport's GPS solution to record their position data via their respective control units 20. Either way, the source of the GPS solution is preferably authenticated.

Once cargo container 10 arrives at the destination import port, then, in step 413, the container 10 is preferably transferred to a secured quarantine waiting area. While in quarantine, a responsible authority (such as, for example, the captain of the freighter) may authorize, in step 414, transfer of trip surveillance data collected by control unit 20 from each cargo container 10 to another interface subsystem for documentation and inspection. Preferably, the data may be transmitted to the interface subsystem of computer system 110 via wireless transmission through antenna 22. However, in situations where wireless transmission is not possible, data may also be transmitted in other methods, such as via a hard line connection via junction box 50 or direct physical transfer and movement of some mass storage device. In these circumstances, direct physical transfer and movement may be the preferred choice. Portable memory device 210 may also be removed from the cargo container 10 and coupled to an import customs system for transfer of the stored customs information.

In step 415, review/inspection of the trip data may commence using the interface subsystem of computer system 110. In step 416, the data for each container 10 may be analyzed in the same manner conducted at the exporting port. Namely, pattern recognition software operating on computer system 110 is preferably utilized to detect any unauthorized entry into cargo container 10, and other surveillance and tracking data (such as that collected from proximity sensors 71-74, GPS antenna 21, etc.) are scanned (preferably automatically via software executing on the processor of computer system 110) to determine if any anomalies exist between the route taken by the transport and the location information for cargo container 10 during the trip.

If any anomaly is detected, then cargo container 10 may be identified as having to undergo more thorough inspection to determine if a security breach has occurred. Inspections may take multiple formats depending on the severity of the breach. For example, they might range from standard manual inspection to an X-ray inspection of the contents of the cargo container 10, or it may be a vigorous review of the data recorded by the surveillance/monitoring subsystem during transit. Once inspection has been completed without incident, or if no anomalies are identified, then the cargo container 10 may be cleared for unloading and allowed into the unloading area.

In step 417, the recorded trip data may be archived to hard storage, such as (but not limited to) tape storage or Digital Video Disk for record keeping. In step 418, the customs authorities may remove the portable memory device 210 for archive copying and re-initialization, as the portable memory device 210 may be reused for subsequent cargo container shipments. Finally, in step 419, the contents of the cargo container 10 may be unloaded by the shipping agency's agents or other authorized personnel.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computer system 110 or control unit 20 to cause a series of operational steps to be performed on the computer system 110 or control unit 20 to produce a computer implemented process such that the instructions that execute on the computer system 110 or control unit 20 provide processes for implementing the functions/acts specified in the flowchart and/or block diagram block(s). These computer program instructions may be provided to the processor of the computer system 110 or control unit 20 such that the instructions, which execute via the processor of the computer system 110 or control unit 20, create means for implementing the functions/acts specified in the flowchart and/or block diagram block(s).

These computer program instructions may also be stored in a computer-readable medium that can direct the computer system 110 or control unit 20 to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A cargo container security system, comprising:
a cargo container including:
at least one sensor for detecting a status of a door on the cargo container, wherein the status of the door is open or closed;
a geographic positioning locator for identifying a location of the cargo container; and
a control unit operatively connected to the at least one sensor and geographic positioning locator for continuously receiving historical data corresponding to at least the status of the cargo container door and location of the cargo container while the cargo container is in transit, the control unit assigning a timestamp to the received historical data and storing the received historical data and associated timestamp in memory; and
a central computer system, including:
a processor; and
memory comprising program instructions, wherein the program instructions are executable by the processor to:
receive the stored historical data upon the arrival of the cargo container at a destination;
analyze, using the processor, the stored historical data to determine whether there are any anomalies associated with the status of ATTORNEY DOCKET No. 1070.002 the cargo container door and/or the location of the cargo container during transit;
generate an alert, using the processor, if an anomaly is identified.

2. The system of claim 1, wherein the anomaly comprises an opening of the cargo container door while the cargo container is in transit, as detected by the at least one sensor.

3. The system of claim 1, wherein the anomaly comprises a deviation of the cargo container from an expected course, as detected by the geographic positioning locator.

4. The system of claim 1, wherein the at least one sensor for detecting the status of the cargo container door includes at least one proximity sensor.

5. The system of claim 1, wherein the at least one sensor for detecting the status of the cargo container door includes at least one surveillance camera.

6. The system of claim 5, wherein the camera is adapted to record visible light and infrared images.

7. The system of claim 1, wherein the geographic positioning locator is an antenna/receiver that communicates with a global positioning system.

8. The system of claim 1, wherein the memory in the control unit includes a hard disk drive storage system.

9. The system of claim 8, wherein the hard disk drive storage system includes an anti-vibration dampening device to safeguard the hard disk drive storage system from damage caused by movement.

10. The system of claim 1, wherein the memory in the control unit includes a solid-state drive.

11. The system of claim 1, wherein the memory in the control unit includes a portable memory device operatively connected to the control unit.

12. The system of claim 11, wherein the portable memory device is operatively connected to the control unit to store customs and is operatively connected to the central computer system when the cargo container arrives at the destination to allow the central computer system to receive the customs data.

13. The system of claim 11, wherein the portable memory device is a universal serial bus flash drive.

14. The system of claim 11, wherein a time-stamped record is kept on the portable memory device every time the portable memory device is operatively connected and disconnected from the control unit.

15. The system of claim 1, wherein the program instructions are further executable by the processor of the central computer system to display the historical data including at least the status of the cargo container door, the location of the cargo container, and their associated timestamps.

16. The system of claim 1, wherein the cargo container includes a wireless transmission antenna for wirelessly transmitting the stored historical data to the central computer system.

17. The system of claim 1, wherein at least the control unit, memory, geographic position locator and at least one sensor draw power from an external power source available on a transport carrying the cargo container.

18. The system of claim 17, wherein the control unit, memory, geographic position locator and at least one sensor draw power from a battery when power supply from the transport is interrupted.

19. The system of claim 1, wherein the historical data is encrypted by the control unit and the program instructions are further executable by the processor of the central computer system to decode the encrypted historical data.

20. A computer-implemented method for secured shipping of a cargo container, comprising:
generating a door position signal using at least one sensor located on the cargo container to continuously monitor a status of a door of the cargo container while the cargo container is in transit, wherein the status of the door is open or closed;
continuously identifying a location of the cargo container while in transit using a geographic positioning locator located on the cargo container;
transmitting historical data to a control unit located on the cargo container and operatively connected to the at least one sensor and geographical positioning locator, wherein the historical data corresponds to at least the status of the cargo container door and location of the cargo container while the cargo container is in transit;
assigning, using the control unit, a timestamp to the received historical data;
storing the received historical data and associated timestamp in memory operatively connected to the control unit;
receiving, in central computer system that includes a processor, the stored historical data upon the arrival of the cargo container at a destination;
analyzing, using the processor, the stored historical data to determine whether there are any anomalies associated with the status of the cargo container door and/or the location of the cargo container during transit; and
generating an alert, using the processor, if an anomaly is identified.

21. The computer-implemented method of claim 20, wherein the anomaly comprises an opening of the cargo container door while the cargo container is in transit, as detected by the at least one sensor.

22. The computer-implemented method of claim 20, wherein the anomaly comprises a deviation of the cargo container from an expected course, as detected by the geographic positioning locator.

23. The computer-implemented method of claim 20, wherein the at least one sensor for detecting the status of the cargo container door includes at least one proximity sensor.

24. The computer-implemented method of claim 20, wherein the at least one sensor for detecting the status of the cargo container door includes at least one surveillance camera.

25. The computer-implemented method of claim 24, wherein the camera is adapted to record visible light and infrared images.

26. The computer-implemented method of claim 20, wherein the geographic positioning locator is an antenna/receiver that communicates with a global positioning system.

27. The computer-implemented method of claim 20, wherein the memory operatively connected to the control unit includes a hard disk drive storage system.

28. The computer-implemented method of claim 27, further comprising providing an anti-vibration dampening device to safeguard the hard disk drive storage system from damage caused by movement.

29. The computer-implemented method of claim 1, wherein the memory operatively connected to the control unit includes a solid-state drive.

30. The computer-implemented method of claim 1, wherein the memory operatively connected to the control unit includes a portable memory device.

31. The computer-implemented method of claim 30, further comprising:
operatively connecting the portable memory device to the control unit to store customs data while the cargo container is in transit; and
operatively connecting the portable memory device to the central computer system when the cargo container arrives at the destination to allow the central computer system to receive the customs data.

32. The computer-implemented method of claim 30, wherein the portable memory device is a universal serial bus flash drive.

33. The computer-implemented method of claim 30, wherein a time-stamped record is kept on the portable memory device every time the portable memory device is operatively connected and disconnected from the control unit.

34. The computer-implemented method of claim 20, further comprising displaying, using the processor of the central computer system, the historical data including at least the status of the cargo container door, the location of the cargo container, and their associated timestamps.

35. The computer-implemented method of claim 20, further comprising wirelessly transmitting the stored historical data to the central computer system using a wireless transmission antenna positioned on the cargo container and operatively connected to the control unit.

36. The computer-implemented method of claim 20, further comprising providing power to at least the control unit, memory, geographic position locator and at least one sensor from an external power source available on a transport carrying the cargo container.

37. The computer-implemented method of claim 36, further comprising providing power to at least the control unit, memory, geographic position locator and at least one sensor draw from a battery when power supply from the transport is interrupted.

38. The computer-implemented method of claim 1, further comprising:
encrypting the historical data using the control unit; and
decoding the encrypted historical data using the processor of the central computer system.

39. A cargo container for secured container shipping, comprising:
at least one sensor for detecting a status of a door on the cargo container, wherein the status of the door is open or closed;
a geographic positioning locator for identifying a location of the cargo container; and
a control unit operatively connected to the at least one sensor and geographic positioning locator for continuously receiving historical data corresponding to at least the status of the cargo container door and location of the cargo container while the cargo container is in transit, the control unit assigning a timestamp to the received historical data and storing the received historical data and associated timestamp in memory;
wherein the stored historical data is analyzed to determine whether there are any anomalies associated with the status of the cargo container door and/or the location of the cargo container during transit and an alert is generated if an anomaly is identified.

40. The cargo container of claim 39, wherein the anomaly comprises an opening of the cargo container door while the cargo container is in transit, as detected by the at least one sensor.

41. The cargo container of claim 39, wherein the anomaly comprises a deviation of the cargo container from an expected course, as detected by the geographic positioning locator.

42. The cargo container of claim 39, wherein the at least one sensor for detecting the status of the cargo container door includes at least one proximity sensor.

43. The cargo container of claim 39, wherein the at least one sensor for detecting the status of the cargo container door includes at least one surveillance camera.

44. The cargo container of claim 43, wherein the camera is adapted to record visible light and infrared images.

45. The cargo container of claim 39, wherein the geographic positioning locator is an antenna/receiver that communicates with a global positioning system.

46. The cargo container of claim 39, wherein the memory in the control unit includes a hard disk drive storage system.

47. The cargo container of claim 46, wherein the hard disk drive storage system includes an anti-vibration dampening device to safeguard the hard disk drive storage system from damage caused by movement.

48. The cargo container of claim 39, wherein the memory in the control unit includes a solid-state drive.

49. The cargo container of claim 39, wherein the memory in the control unit includes a portable memory device operatively connected to the control unit.

50. The cargo container of claim 49, wherein the portable memory device is disconnected from the control unit and operatively connected to a central computer system when the cargo container arrives at the destination to allow the central computer system to receive and analyze customs data stored on the portable memory device.

51. The cargo container of claim 49, wherein the portable memory device is a universal serial bus flash drive.

52. The cargo container of claim 49, wherein a time-stamped record is kept on the portable memory device every time the portable memory device is operatively connected to and disconnected from the control unit.

53. The cargo container of claim 39, further comprising a wireless transmission antenna for wirelessly transmitting the stored historical data to a central computer system.

54. The cargo container of claim 39, wherein at least the control unit, memory, geographic position locator and at least one sensor draw power from an external power source available on a transport carrying the cargo container.

55. The cargo container of claim 54, further comprising a battery for providing power to the control unit, memory, geographic position locator and at least one sensor when power supply from the transport is interrupted.

56. The cargo container of claim 1, wherein the historical data is encrypted by the control unit.
